(19) United States
(12) Patent Application Publication
(10) Pub. No.: US 2002/0112512 A1
(43) Pub. Date: Aug. 22, 2002

(54) Lock device to be unlocked by pushing replaceable tumbler disks with a key thereof

(76) Inventor: Chi-Yuan Li, Taipei (TW)

Correspondence Address: CHI-YUAN LI, P.O. Box 96-405, Taipei, 106, TW

(21) Appl. No.: 09/788,102

(22) Filed: Feb. 16, 2001

(51) Int. Cl. E05B 29/04

(52) U.S. Cl. 70/366

(57) ABSTRACT

A lock device to be unlocked by pushing replaceable tumbler disks with a key thereof, which comprises a lock casing and an inner transmission assembly; the inner transmission assembly includes a lock cylinder, a plurality of tumbler disks, a plurality of springs and a tail-fixed member, and it is mounted in the cylindrical hole of the lock casing; the outer side of the lock casing is furnished with two symmetrical flanges; each of the flanges has a cylindrical groove for receiving a retaining bar, which is furnished with a plurality of round grooves; the height of the cylindrical surface between every two round grooves is variable; such variety and the replaceable retaining bars and the replaceable key enable the lock device to vary in terms of new unlocking combination.

### BACKGROUND OF THE INVENTION

1. Field of the Invention

This invention relates to a lock device, and particularly to a lock device to be unlocked by pushing replaceable tumbler disks with a key thereof.

2. Description of the Prior Art

In the conventional lock device under U.S. Pat. No. 5,335,520, “A Spread and Sliding Type of Lock”, it comprises a lock casing mounted with a lock cylinder; the inside of the lock casing is furnished with alternate sliding grooves and ring-shaped grooves. The lock cylinder is mounted with a plurality of sliding slices and one fixed slice; the inner side of every sliding slice has a hole with a push plate, of which the length is variable. The outer edge of every sliding slice has a fitting edge to be mated with the sliding groove in the lock casing. A positioning spring is mounted between two sliding slices; a push spring stronger that the positioning spring is mounted between a fixed slice and a sliding slice so as to fit the key, which has a cascade edge on one side. The space among the cascade edge of the key is so designed as to fit with the space among the ring-shaped groove in the lock casing. As soon as a key is plugged into a key hole, the sliding slices will be pushed to positions corresponding to that of the ring-shaped grooves respectively so as to turn and to unlock the lock device. After the key is pulled out all the sliding slices will be pushed forwards to he lock-up position by means of the push spring.

In a conventional replaceable lock cylinder of a lock device, the lock usually comprises a master key and several or decades of different keys and replaceable lock cylinders; the master key thereof can unlock several locks, and it can turn the replaceable lock cylinder to zero position; then, a separate key is used to turn the lock to original position; in other words, the lock can be unlocked by using that separate key and the master key only so as to provide a variety.

### SUMMARY OF THE INVENTION

The prime object of the present invention is to provide an improvement for application, “A Lock Device To Be Unlocked by Pushing Tumbler Disks therein” under U.S. patent was filed, wherein a separate inner transmission assembly is mounted in a cylindrical hole of the lock casing; the distance between every two tumbler disks and the size of the cylindrical hole of every tumbler disk can be varied. Both sides of the lock casing are furnished with two symmetrical flanges respectively for receiving two replaceable retaining bars; the groove space between every two round grooves of the retaining bar is variable in correspondence with the variety of the ring-shaped shoulder of the key, and therefore the lock device can easily be disassembled for changing its new unlocking combination.

Another object of the present invention is to provide a lock device, in which both sides of the lock casing are furnished with two symmetrical flanges; each of the flanges has a cylindrical groove for receiving a retaining bar which has a plurality of round grooves. The space among the round grooves is variable so as to adjust the push distance of the tumbler disks respectively upon unlocking the lock.

Still another object of the present invention is to provide a lock device, in which the key surface of the key is furnished with a plurality of ring-shaped shoulders; the diameter of each ring-shaped shoulder and the length of each cylindrical surface can be varied. The cylindrical holes in center of the three tumbler disks can also be varied in accordance with the ring-shaped shoulders on the key surface so as to provide more variety by means of the tumbler disks and the ring-shaped shoulders.

A further object of the present invention is to provide a lock device, in which the surface of the key is furnished with a plurality of ring-shaped shoulders; the height of every ring-shaped shoulder is designed to fit the corresponding round groove on the retaining bar; when a key is plugged into the positioning hole of the lock casing to push the tumbler disks, every disk will be pushed to a position corresponding to the specific round groove of the retaining bars on both sides thereof. When the key drives the inner transmission assembly to rotate, every tumbler disk will not be hindered until the lock being unlocked.

A still further object of the present invention is to provide a lock device, in which the diameter of the center cylindrical holes of the three tumbler disks of the inner transmission assembly is variable, and such variation is varied with the height of every ring-shaped shoulder of the key so as to provide a new unlocking combination.

Yet another object of the present invention is to provide a lock device, in which the diameter of the center cylindrical holes of the three tumbler disks is variable, and such variation is varied with the height of every ring-shaped shoulder of the key. A maser key is designed to able to unlock a set of lock devices by pushing the three tumbler disks to the unlocked position. The master key can control or unlock a plurality of lock devices, but each lock device also has its separate key.

Yet still another object of the present invention is to provide a lock device, in which the retaining bars mounted in the cylindrical grooves of the symmetrical flanges on both sides of the lock casing and the key for pushing the three tumbler disks are all round cylinders. The position variation of the round grooves of the retaining bars and the variation of the ring-shaped shoulders of the key are to be done by means of digital control of a CNC lathe so as to provide a simple and quick assembly between the key and the retaining bars for every new replaceable unlocking combination; a user can easily change the unlocking combination of a lock device by simply removing the used replaceable parts.

### BRIEF DESCRIPTION OF THE DRAWINGS

FIG. 1 is a disassembled view of the present invention, showing the lock device and a key thereof.

FIG. 2 is a further disassembled view of the present invention.

FIG. 3 is a sectional view of the present invention, showing the device in lock-up condition.

FIG. 4 is a sectional view of the present invention, showing the device in unlocked condition.

FIG. 5 is a sectional view of the present invention, showing the inner structure of the lock casing.

FIG. 6 is a perspective view of the present invention, showing the retaining bars disassembled from the lock casing.

FIG. 7 is a perspective view of the present invention, showing the retaining bars assembled together with the lock casing.

FIG. 8 is a sectional view of the present invention, showing the relation between the first tumbler disk and the main spring.

FIG. 9 is a sectional view of the present invention, showing a key pushing the first tumbler disk to move.

FIG. 10 is a sectional view of the present invention, showing the relation between the second tumbler disk and the minor springs on both sides thereof.

FIG. 11 is a sectional view of the present invention, showing the key pushing the second tumbler disk to move.

FIG. 12 is a sectional view of the present invention, showing the relation between the third tumbler disk and the minor springs on both sides thereof.

FIG. 13 is a section al view of the present invention, showing the key pushing the third tumbler disk to move.

FIG. 14 is a sectional view of the present invention, showing along line 14-14 in FIG. 3.

FIG. 15 is a sectional view of the present invention, showing along line 15-15 in FIG. 4.

FIG. 16 is a sectional view of the present invention, showing the three tumbler disks being pushed with the ring-shaped shoulders of the key to have the first lock unlocked.

FIG. 17 is a sectional view of the present invention, showing the three tumbler disks being pushed with the ring-shaped shoulders of the key to have the second lock unlocked.

FIG. 18 is a sectional view of the present invention, showing the three tumbler disks being pushed with the ring-shaped shoulders of the key to have the third lock unlocked.

FIG. 19 is a sectional view of the present invention, showing the three tumbler disks being pushed with the ring-shaped shoulders of the key to have the fourth lock unlock.

FIG. 20 is a plan view of the present invention, showing the structure of the ring-shaped shoulders of the key.

### DETAILED DESCRIPTION OF THE PREFERRED EMBODIMENT

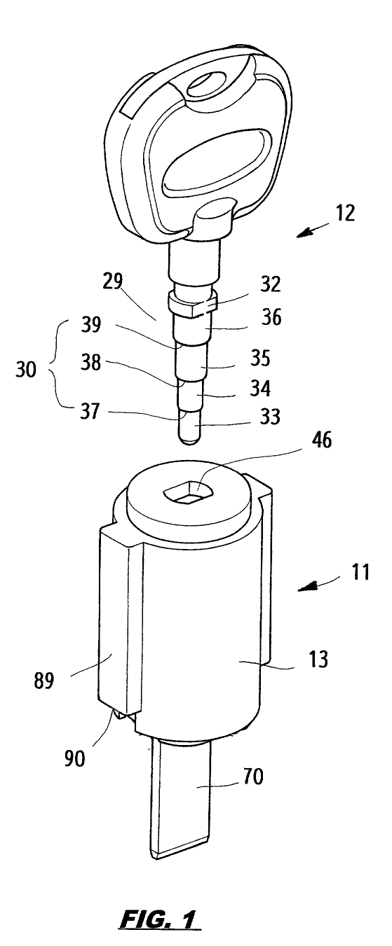

This invention relates to a lock device to be unlocked by pushing replaceable tumbler disks with a key thereof; as shown in FIGS. 1 to 4, the lock device 11 comprises a key 12, a lock casing 13, an inner transmission assembly 14, limit ring 84, transmission plate 70 and a retaining ring 25. The inner transmission assembly 14 includes a plurality of parts, and it is fitted in the cylindrical hole 41 of the lock casing 13; one end of the cylindrical hole 41 is mounted with a transmission plate 70, a limit ring 84 and a retaining ring 25. The cylindrical key surface 29 of the key 12 is furnished with a plurality of ring-shaped push shoulders 30, which are designed in accordance with the positions of the three tumbler disks 16, 17 and 18 of the inner transmission assembly 14 for unlocking the lock device; when the key 12 is plugged into the lock casing 13, the ring-shaped push shoulders 30 will push the three tumbler disks 16,17 an 18 into the slots 43A 43B and 43C respectively among the cylindrical surfaces 42; then, turn the key 12 so as to drive the inner transmission assembly 14 to move, and to have the three tumbler disks 16, 17 and 18 engaged with the slots 43 respectively, and then the lock device is unlocked. In the event of the three tumbler disks 16,17 and 18 not being mated with the three slots 43A, 43B and 43C simultaneously, the lock device will not be unlocked.

Referring to FIGS. 1 to 7, the center of the lock casing 13 of the lock device 11 has a cylindrical hole 41 for receiving a key through a positioning hole 46. Both outer sides of the lock casing 13 are furnished with two symmetrical flanges 89 respectively. The center of each flange 89 has a cylindrical groove 90 to be tangent to the cylindrical hole 41 of the lock casing. The cylindrical groove 90 is used for receiving a retaining bar 27 having a plurality of round grooves 43. The cylindrical surfaces 42 thereof are used for limiting the turn of the inner transmission assembly 14, i.e., limiting the turning angle of the inner transmission assembly 14 upon unlocking the lock device. The retaining bars 27 are to be plugged into the cylindrical grooves 90 on both sides of the lock casing 13 respectively after the inner transmission assembly 14 being assembled in the cylindrical hole 41 of the lock casing 13. The surface of the retaining bars each have furnished with a plurality of round grooves 43A, 43B and 43C; the distances 44A, 44B AND 44C between every two round grooves is designed in advance so as to facilitate the three push shoulders 30 on the cylindrical key surface 29 of the key 12 to push the three tumbler disks 16, 17 and 18 of the inner transmission assembly 14 to the specific position of the round grooves 43 of the retaining bars 27 so as to have the lock device 11 unlocked.

The inner transmission assembly 14 in the central cylindrical hole 41 of the lock casing 13 includes a lock cylinder 15, three tumbler disks 16, 17 and 18, a main spring 19, a plurality of minor springs 20, 21, 22 and 23, and a tail-fixed block 24; the upper end of the lock cylinder 15 has a disk 48, of which the center has an engaging slot 49. The engaging slot 49 of the inner transmission assembly 14 is used for receiving the engaging shoulder 32 of the key 12; the key 12 is used for driving the inner transmission assembly 14 to turn; under the disk 48 of the lock cylinder 15, there are two symmetrical curved members 51 and 52; the inner surfaces of the two curved members 51 and 52 form into a cylindrical groove 53; both sides of the two curved members 51 and 52 are furnished with symmetrical round grooves 54, 55, 56 and 57 respectively; the outer edge of each of the round grooves 54, 55, 56 and 57 is furnished with an elongate slot 71, 72, 73 and 74. The two symmetrical curved members 51 and 52 are mounted with three tumbler disks 16, 17 and 18. The cylindrical groove 53 between the two symmetrical curved members 51 and 52 is divided into two guide spaces (or two guide passages). The cylindrical groove 53A above the three tumbler disks 16, 17 and 18 is used for receiving the key 12 to drive the three tumbler disks 16,17 and 18 to move so as to unlock the lock device. A cylindrical groove 53B under the three tumbler disks 16, 17 and 18 is used for receiving a main spring 19, which enables the three tumbler disks to push upwards normally.

The three tumbler disks 16, 17 and 18 mounted around the two symmetrical curved members 51 and 52 of the lock cylinder 15 are furnished respectively with symmetrical notches 58, 62 and 66. The width and depth of the three notches 58, 62 and 66 are designed in accordance with the width and depth of the cylindrical surface 42 of the cylindrical hole 41 in the lock casing 13. The three tumbler disks 16, 17 and 18 are mounted on the cylindrical surface 42 in the cylindrical hole 41 of the lock casing 13 via the symmetrical notches 58, 62 and 66; the cylindrical surface 42 is used for limiting the rotating of the inner transmission assembly 14. After the three tumbler disks 16, 17 and 18 are pushed to position opposite to the corresponding slots 43 of the cylindrical surface 42 in the lock casing 13, the three tumbler disks 16,17 and 18 can be driven to slide into the slots 43 of the cylindrical surface 42 so as to enable the inner transmission assembly 14 to rotate and to unlock the lock device.

The symmetrical curved members 51 and 52 of the lock cylindrical 15 are used for mounting the three tumbler disks 16, 17 and 18; all the three tumbler disks have the same thickness, and the outer edges thereof are furnished with three notches 58, 62 and 66 respectively, having the same width and depth; they also have the same curved holes 59, 63 and 67 respectively to enable them to mount on the symmetrical curved members 51 and 52. The center cylindrical holes 60, 64 and 68 of the three tumbler disks 16, 17 and 18 are designed in a cascade form. The cylindrical hole 60 of the first tumbler disk 16 has the least diameter, while the cylindrical hole 64 of the second tumbler disk 17 has a diameter larger than that of the first tumbler disk 16; the third tumbler disk 18 has a diameter larger than that of the second tumbler disk 17. The center cylindrical holes 60, 64 and 68 of the three tumbler disks are so designed as to fit the cascade-shaped cylindrical key surface 29 respectively. After the key 12 is plugged into the cylindrical groove 53A of the inner transmission assembly 14 in the lock device 11, the guide stem 33 of the cylindrical key surface 29 will go through the cylindrical holes 68, 64 and 60 of the three tumbler disks 16, 17 and 18; then, the first push shoulder 37 between the guide stem 33 and the first cylindrical surface 34 will touch and push the cylindrical hole 60 of the first tumbler disk 16; next, the second push shoulder 38 between the first cylindrical surface 34 and the second cylindrical surface 35 will touch and push the cylindrical hole 64 of the second tumbler disk; then, the third push shoulder 39 between the second cylindrical surface 35 and the third cylindrical surface 36 will touch and push the cylindrical hole 68 of the third tumbler disk 18; finally, the three tumbler disks 16, 17 and 18 will be pushed into the slots 43 of cylindrical surface 42 of the lock casing 13; in that case the inner transmission assembly 14 can be turned for unlocking the lock device.

The diameters of the cylindrical holes 60, 64 and 68 of the three tumbler disks 16, 17 and 18 can be designed into at least six (6) sizes; the disks are designed into stairs arrangement so as to provide more varieties for the distances among the three tumbler disks 16, 17 and 18. The ring-shaped shoulders 30 of the key 12 have a specific hole 41 of the lock casing 13 can receive three tumbler disks 16, 17 and 18 only; each of the tumbler disks 16, 17 and 18 can be pushed at a different distance so as to have more varieties provided for unlocking the lock device.

In order to enable the three tumbler disk 16, 17 and 18 mounted on the two symmetrical curved members 51 and 52 of the lock cylinder 15 to return to normal position after being pushed for unlocking, the symmetrical curved holes 63 and 67 of the second and third tumbler disks 17 and 18 are furnished with diagonal and symmetrical stud members 61 and 65, which are so designed as to fit the round grooves 54, 55, 56 and 57, and the elongate slot 71, 72, 73 and 74. After the symmetrical stud members 61 of the third tumbler disk 18 are mounted into the round grooves 55 and 57 of the symmetrical curved members 51 and 52, two minor springs 22 and 23 will be mounted in the round grooves 55 and 57 under the stud members 61. The pushing force of the two minor springs 22 and 23 can normally push the third tumbler disk 18 upwards; two symmetrical stud members 65 of the second tumbler disk 17 are mounted in two round grooves 54 and 56 of the two symmetrical curved members 54 and 56, and then two minor springs 20 and 21 are mounted in two round grooves 54 and 56 respectively under the stud members 65. The two minor springs 20 and 21 will provide a pushing force to push the second tumbler disk upwards normally. The symmetrical curved members 51 and 52 of the lock cylinder 15 are mounted with the third tumbler disk 18, and the second and first tumbler disks 17 and 16 in sequence. The main spring 19 is mounted in the cylindrical groove 53 under the first tumbler disk 16; the main spring 19 is mounted under the first tumbler disk 16 to provide the three tumbler disks 16, 17 and 18 with a main pushing-up force.

The symmetrical curved members 51 and 52 of the lock cylinder 15 are designed for receiving the third tumbler disk 18, the second tumbler disk 17 and the first tumbler disk 16 in a regular sequence. The two symmetrical curved members 51 and 52 are furnished with four round grooves 54, 55, 56 and 57 respectively so as to load four minor springs 20, 21, 22 and 23 respectively. A cylindrical groove 53 is furnished between the two curved grooves 51 and 52 for receiving a main spring 19. During assembling operation, a tail-fixed member 24 having recess holes is mounted to be the lock cylinder 15 finally to form into a single unit; then the three tumble disks 16, 17 and 18 on the two cured members 51 and 52 in the lock cylinder 15 are pushed to the upper end thereof by means of the main spring 19. After the inner transmission assembly 14 is mounted in the cylindrical hole 41 of the lock Casing 13, adjust the three tumbler disks 16, 17 and 18 and the curved notches 58, 62 and 66 thereof so as to have them face the cylindrical grooves 90; then, plug the two retaining bars 27 in the two cylindrical grooves 90 respectively. The retaining bars 27 can limit the inner transmission assembly 14 from rotating. The lower end of the tail fixed member 24 has an elongate slot 88 for receiving a transmission plate 70, which is mounted with a limit ring 84 and a retaining ring 25 so as to have the assembly positioned in the cylindrical hole 41 of the lock casing 13.

As shown in FIGS. 1 to 4, the bottom of the three tumbler disks 16, 17 and 18 in the inner transmission assembly 14 inside the cylindrical hole 41 of the lock casing 13 is pushed upwards normally, i.e., the three tumbler disks 16, 17 and 18 are attached closely to the disk 48 of the lock cylinder 15. To unlock the lock device, a proper key 12 can be plugged into the center positioning hole 46 of the lock casing 13 through the engaging slot 49 of the lock cylinder 15 so as to push the three tumbler disks 16, 17 and 18 to the slots 43 of the cylindrical surfaces 42 in the lock casing 13; the inner transmission assembly 14 and the lock casing 13 are set in unlocking state, and the engaging shoulder 32 of the key 12 will be mated with the engaging slot 49 of the disk 48 of the lock cylinder 15; as soon as the key 12 is turned, the lock device will be unlocked.

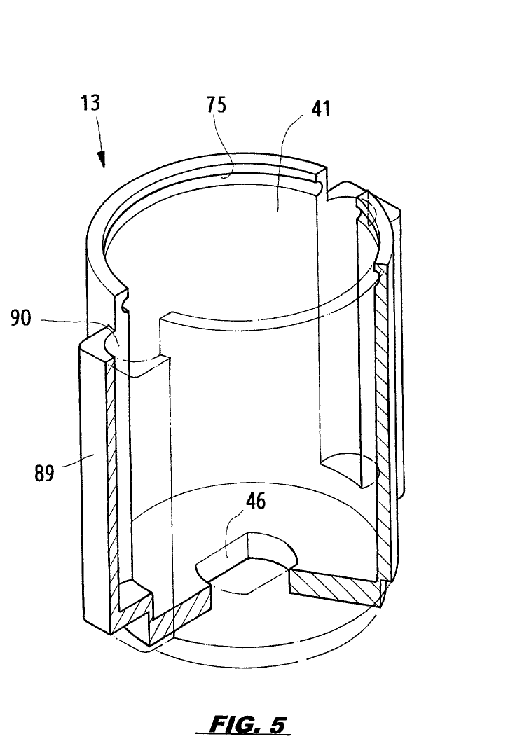

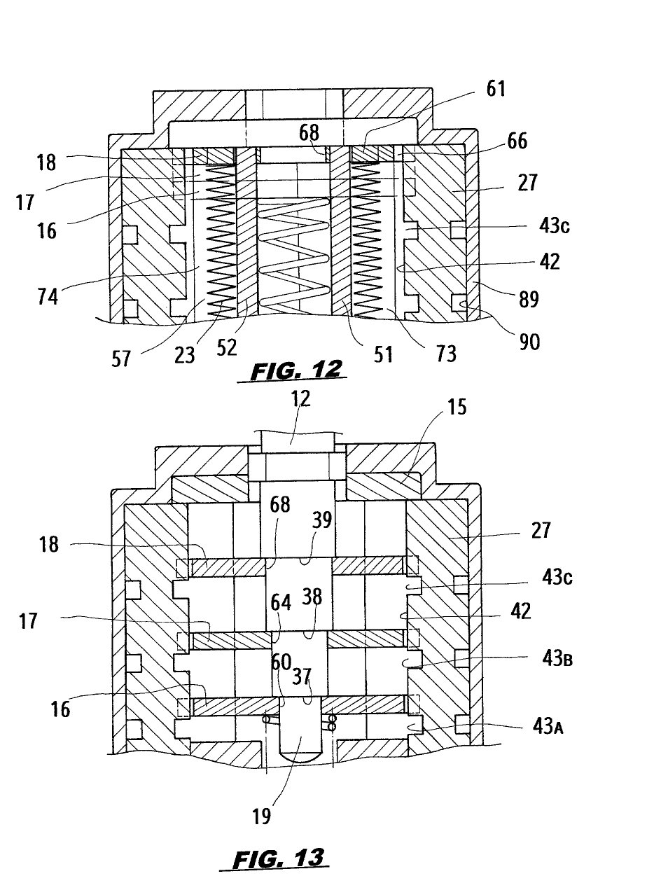

As shown in FIGS. 1 to 4, 8, 9, 14 and 15, the three tumbler disks 16, 17 and 18 mounted on the lock cylinder 15 are pushed and attached closely to the upper end of the lock cylinder 15 as a result of the pushing force of the main spring 19; the notches 58, 62 and 66 on the edges of the three tumbler disks 16, 17 and 18 will mated with the cylindrical surfaces 42 in the upper part of the lock casing 13 respectively, and then the three tumbler disks 16, 17 and 18 are caught in place, being unable to turn; as soon as a proper key 12 is plugged into the positioning hole 46 of the lock casing 13, the front guide stem 33 of the key 12, having the least diameter, will go through the positioning hole 46, the disk 48 of the lock cylinder 15 and the center cylindrical holes 68, 64 and 60 of the three tumbler disks 18, 17 and 16, and finally the first push shoulder 34 on the front end of the first cylindrical surface 34 will be in contact with the top side of the cylindrical hole 60 of the first tumbler disk 16 so as to push the first tumbler disk 16 to move downwards; simultaneously, the main spring 19 will be pushed downwards; if the key 12 is pulled out, the first tumbler disk 16 will be pushed back with the main spring 19.

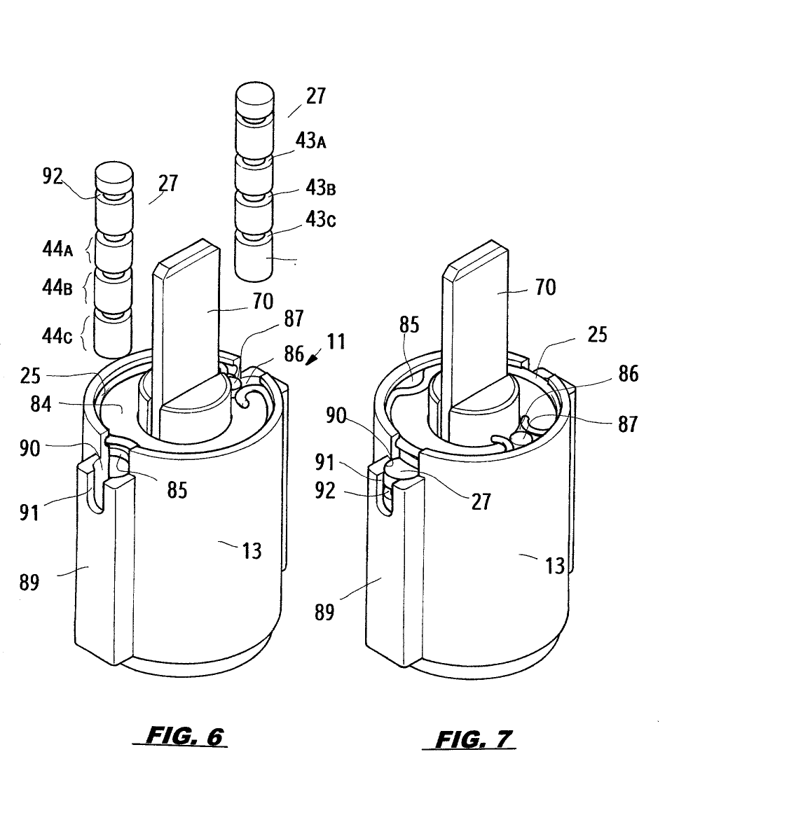

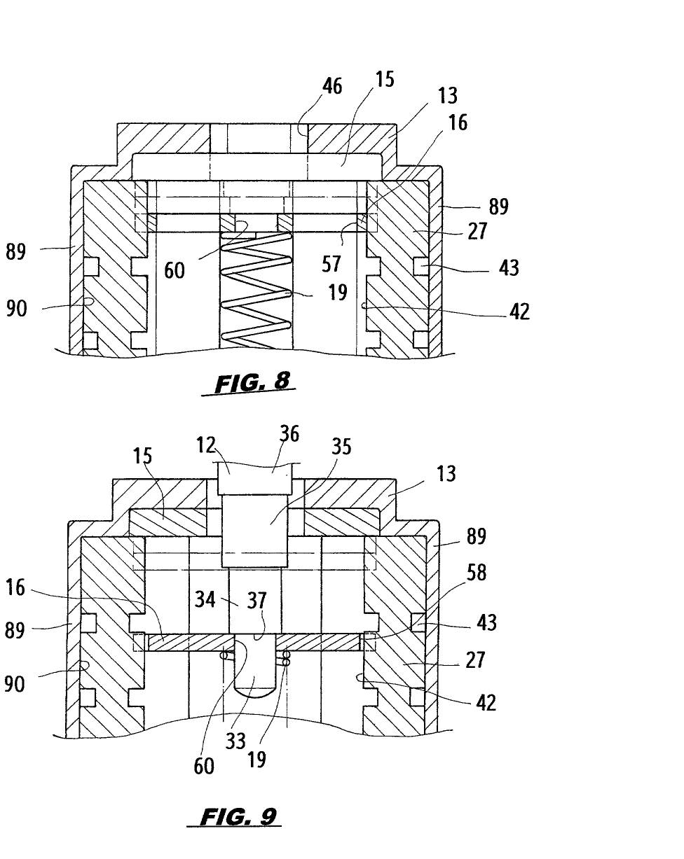

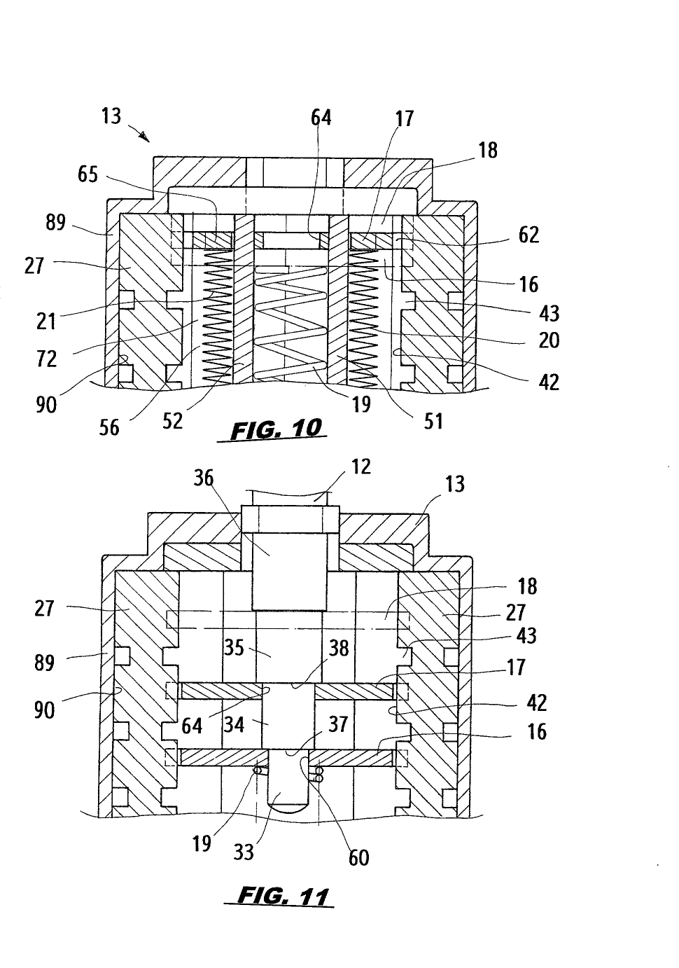

After the first tumbler disk 16 is pushed with the first push shoulder 37 of the key 12, as shown in FIGS. 10 and 11, the second push shoulder 38 on the end of the second cylindrical surface 35 will push the second tumbler disk 17; as shown in FIGS. 12 and 13, the third push shoulder 39 on the end of the third cylindrical surface 36 will push the third tumbler disk 18 to move. Before the three tumbler disks 16, 17 and 18 are pushed, the slot spaces 44 among the slots 43A, 43B and 43C of the symmetrical cylindrical surfaces 42 in the cylindrical hole 41 have been designed and set in advance. Th length of the first cylindrical surface 34 of the key 12 is equal to the sum of the slot space 44A and 43B, and the thickness of the first tumbler disk 16. The length of the second cylindrical surface 35 of the key 12 is equal to the sum of the slot space 44B between the slots 43B and 43C, and the thickness of the first tumbler disk 16. The length of the second cylindrical surface 35 of the key 12 is equal to the sum of the slot space 44B between the slots 43B and 43C, and the thickness of the second tumbler disk 17; also the length of the third cylindrical surface 36 of the key 12 is equal to the sum of the slot space 44C between the slot 43C and the outer surface of the lock casing 13, and the thickness of the first tumbler 16. If one of the push surfaces of the cylindrical key surface 29 of the key 12 is unable to match for the position variety of slots 43 of the cylindrical surfaces 42 in the lock casing 13, the key 12 would fail to push the three tumbler disks 16, 17 and 18 to positions opposite to the slots 43 of the cylindrical surfaces 42 respectively and simultaneously; in that case, the three tumbler disks 16, 17 and 18 will be limited with the cylindrical surfaces 42 to be unable to turn for unlocking the lock device.

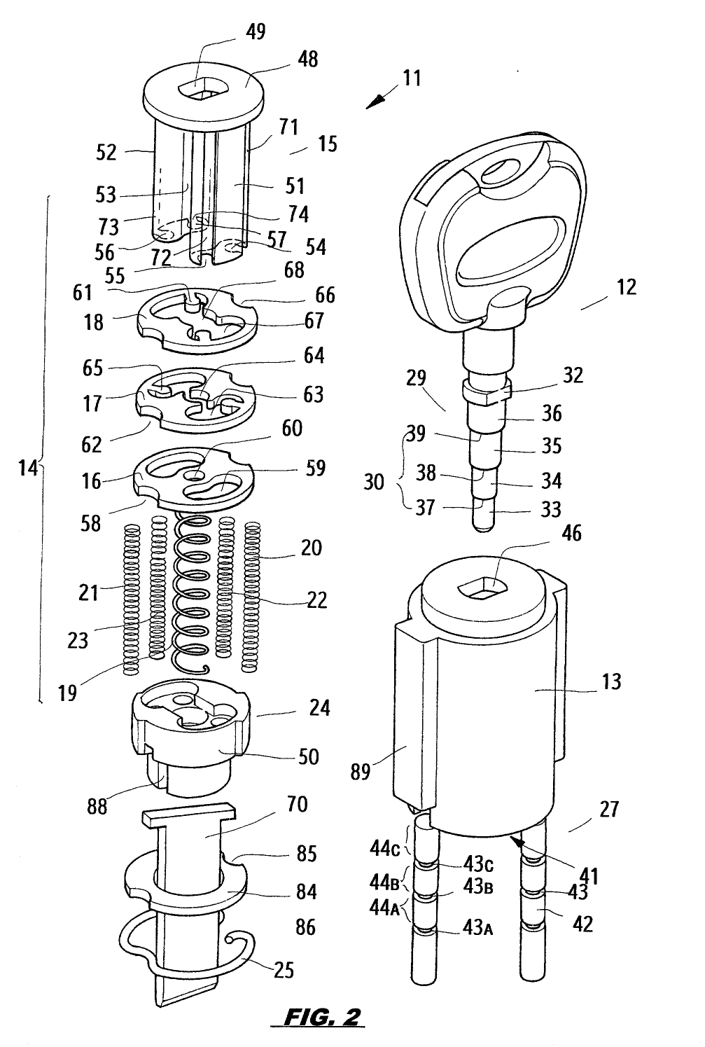

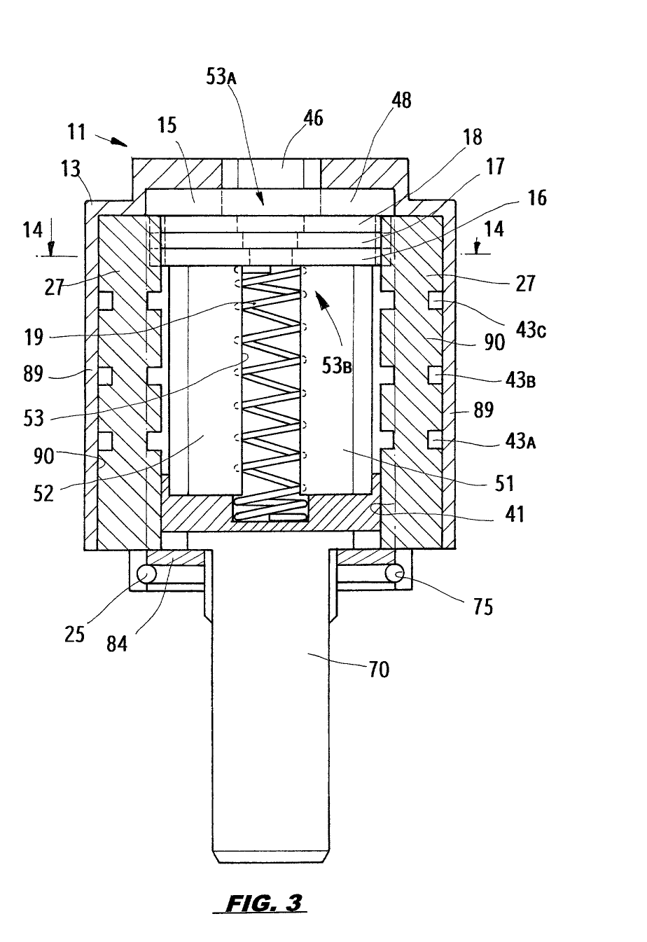

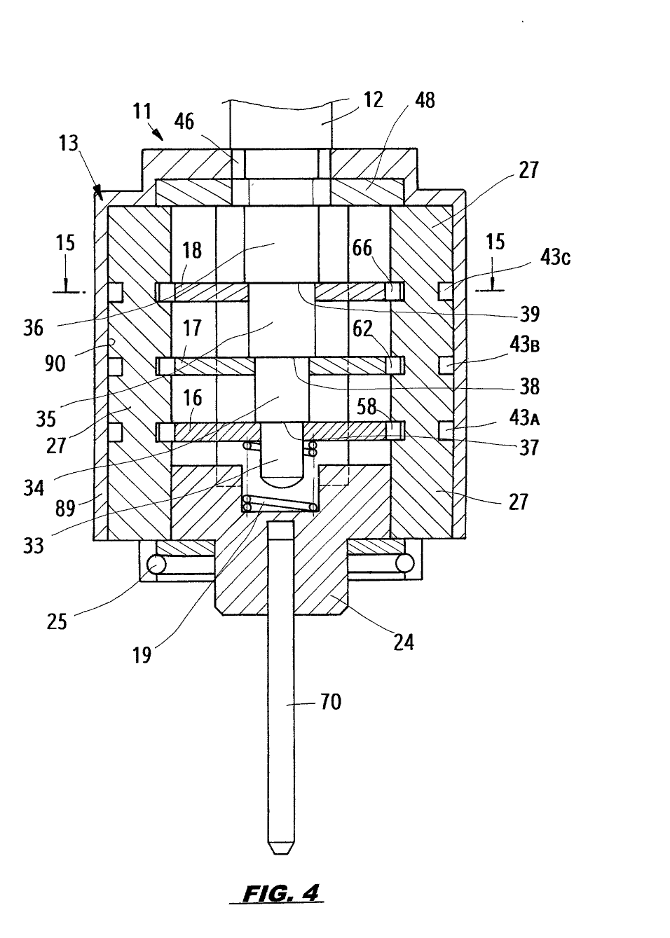

To unlock the lock device with a key 12 as shown in FIGS. 1 to 3, 8 and 9, the guide stem 33 on the front end of the key 12 should be plugged through the positioning hole 46 of the lock casing 13, the engaging slot 49 of the lock cylinder 15, the cylindrical hole 68 of the third tumbler disk 18, the cylindrical hole 64 of the second tumbler disk 17 and the cylindrical hole 60 of the first tumbler disk 16 so as to have the first push shoulder 37 touched the top side of the center cylindrical hole 60 of the first tumbler disk 16; when the key 12 is pushed, the first tumbler disk 16 will be pushed downwards (as shown in FIG. 9); then, the key 12 is pushed in continuously so as to have the second push shoulder 38 of the first cylindrical surface 34 pushing the second tumbler disk 17 to move downwards (as shown in FIG. 11); then, the third push shoulder 39 of the second cylindrical surface 35 will push the third tumbler disk 18 (as shown in FIG. 13); finally, the engaging shoulder 32 of the key 12 is plugged into the disk 48 of the lock cylinder 15 (as shown in FIGS. 4,15) so as to have the three tumbler disks 16, 16 and 18 pushed in to the slots 43 of the cylindrical surfaces 42 respectively, and to have the three tumbler disks 16, 17 and 18 turned without being hindered by the cylindrical surfaces 42, and then the inner transmission assembly 14 will be driven to turn so as to have the transmission flange 70 under the tail-fixed member 24 driving he outer transmission member to move; when the key 12 drives the inner transmission assembly 14 to rotate as shown in FIG. 2, the tail-fixed member 24 on the inner transmission assembly 14 has a rotation-limit groove 50, of which both ends have two stop blocks to be in contact with the cylindrical surfaces 42 of the retaining bars 27 so as to limit the inner transmission assembly 14 to rotate at a given angle.

According to the aforesaid description, it is apparent that the inner transmission assembly 14 includes a lock cylinder 15, three tumbler disks 16, 17 and 18, a main spring 19, a plurality of minor springs 20, 21, 22 and 23, and a tail-fixed member 24. The bottoms of the three tumbler disks 16,17 and 18 are pushed with the main spring 19 to the highest position; the cylindrical holes 60, 64 and 68 of the three tumbler disks, and the symmetrical curved holes 59, 63 and 67 on both sides thereof are designed into a fixed form in advance; therefore, the inner transmission assembly 14 of the lock device 11 can be varied by means of the cylindrical holes 60,64 and 68; the diameters of the ring-shaped shoulders 30 of the key surface 29 of the key 12 should also be varied accordingly. The pushed distance of the three tumbler disks 16,17 and 18 also has a given variety so as to provide the lock device with a plurality of varieties in unlock operation.

After the inner transmission assembly 14 is mounted in the cylindrical hole 41 of the lock casing 13, a transmission plate 70 is plugged into the elongate slot 88 of the tail-fixed member 24; then, the transmission plate is mounted with a limit ring 84, and then a retaining ring 25 is fitted in a ring-shaped groove 75 in the cylindrical hole 41 so as to prevent the inner transmission assembly 14 from moving out of place.

As shown in FIGS. 2, 6 and 7, the limit ring 84 mounted on the end of the cylindrical hole 41 is furnished with symmetrical round notches 85 in order to facilitate the replacement of the retaining bars 27 of the lock device 11; the limit ring 84 also has a positioning bead 87. The retaining ring 25 mounted on the outer side of the limit ring 84 is furnished with a notch 86, which is corresponding to the position of the round notch 85 of the limit ring 84. Both ends of the retaining ring 25 have two bent parts to be mounted on both sides of the positioning bead 87 of the limit ring 84 so as to have the limit ring 84 and the retaining ring 25 retained on the outer end of the cylindrical hole 41 of the lock casing 13. To replace the retaining bar 27, it can be done by directly push-and-turn method to have the cylindrical grooves 90 in the flanges 89 on both sides of the lock casing 13 aligned with the outside, and then plug the retaining bars 27 into the cylindrical grooves 90 respectively until the ends of the retaining bars 27 are on the same level of the ends of the cylindrical grooves 90 respectively. The outer wall of each cylindrical grooves 90 is furnished with a cut slot 91; the retaining bar has a ring groove 92 which can facilitate the retaining bar 27 to be pulled out upon changing new retaining bars (27) and new key so as to enable the luck device 11 to be varied if necessary.

The retaining bars 27 plugged into the cylindrical grooves 90 of the two symmetrical flanges 89 and the key surface 29 of the key 12 used for pushing the three tumbler disks 16,17 and 18 to unlock the lock device are all designed into a cylinder shape. The position variety of the round grooves 43 of the retaining bars 27 and the variety of the ring-shaped shoulder 30 on the key surface 29 of the key are all to be done by means of a CNC lathe having digital control; then, they can be assembled together simply and quickly, i.e., the key 12 and the retaining bars 27 can be formed into a plurality of sets in terms of variety for quick replacement if necessary; in other words, a user can easily have a new lock device simply by turning the retaining ring 25 and pulling out the previous the retaining bars 27 and replacing with a new unlocking combination.

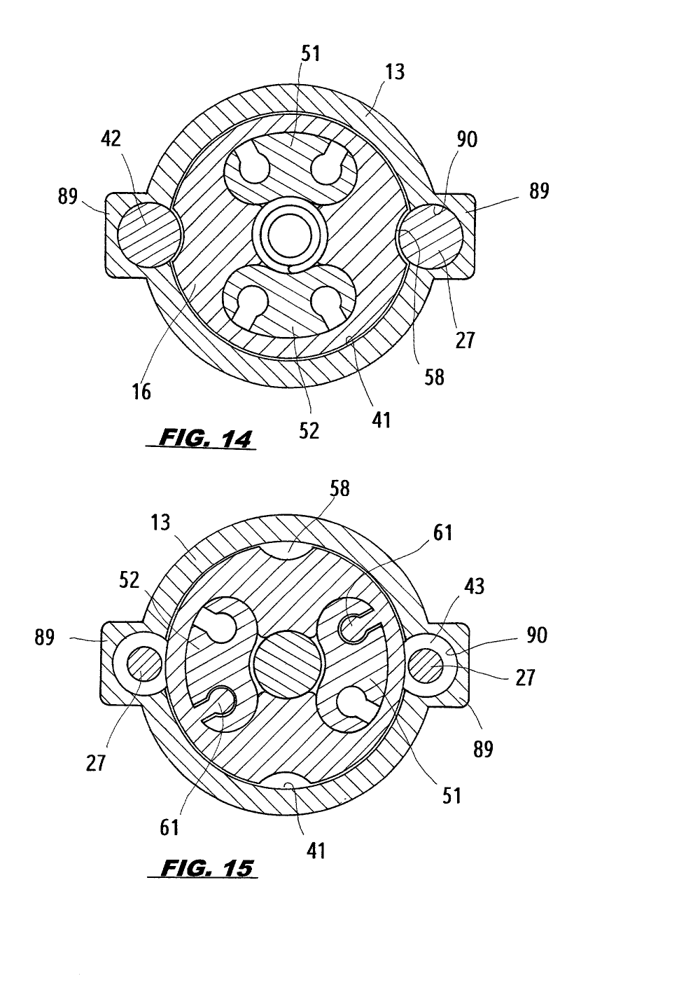

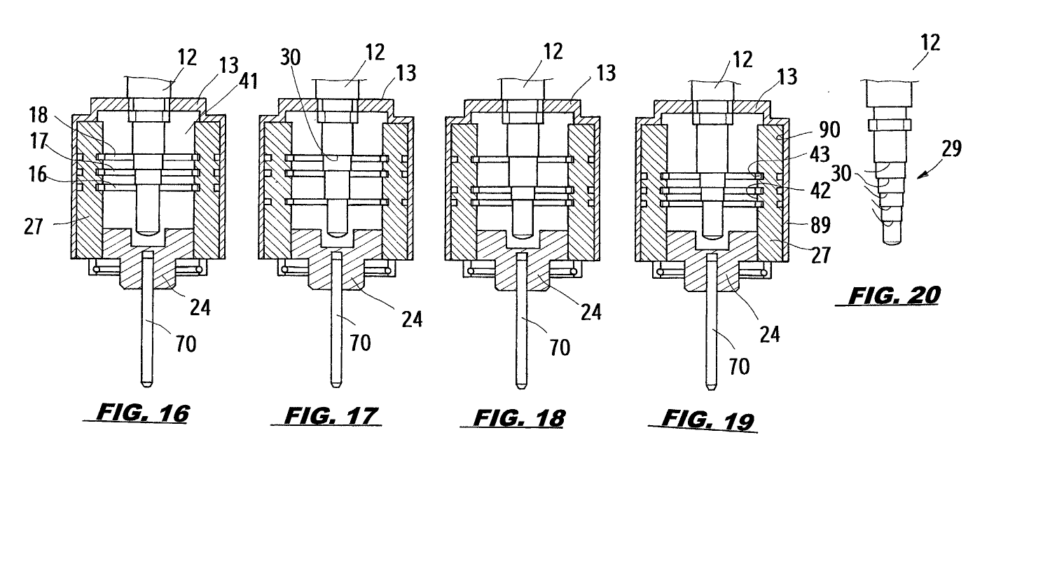

Several sets of replaceable retaining bars 27 and keys 12 are shown in FIGS. 16 to 20; the inner transmission assembly 14 mounted in the cylindrical hole 41 of the lock casing 13 can receive three tumbler disks 16,17 and 18 only, and therefore can provide one set of master keys 12 and a plurality of separate lock devices 11; as shown in FIG. 20, the key surface 29 of the master key is designed into a regular stair-case type of ring-shaped shoulders 30; the distance between two ring-shaped shoulders 30 can be varied (showing an equal distance in FIG. 20). The master key 12 can quickly unlock the lock devices 11 as shown in FIGS. 16 to 20 (or more lock devices of the kind); each separate lock device 11 has a sets of retaining bars 27 and key surfaces 29, i.e., one key can only unlock a specific lock unless using a master key 12, which can push the three tumbler disks 16,17 and 18 to the corresponding positions of the round grooves 43 of the retaining bars 27 simultaneously, and then the inner transmission assembly 14 can be turned to drive the transmission plate 70 to rotate for unlocking the lock device.

According to the aforesaid description of the embodiment, it has been disclosed completely that the cylindrical grooves 90 in the symmetrical flanges 89 of the lock casing 13 of the lock device 11 can have the two replaceable retaining bars 27 plugged therein; to replace the inner parts of the lock device 11, simply pull out the previous retaining bars 27 in the cylindrical grooves 90, and replace a new set of retaining bars 27 and key 12, and then a new unlocking combination is ready. Since the embodiment has disclosed the structure thereof completely, it is clear that the present invention has provided an obvious improvement thereto, which is never anticipated and achieved by any person in the field; the present invention is deemed unique in terms of structure.

What is claimed is:

1. A lock device to be unlocked by pushing replaceable tumbler disks with a key thereof comprising:
a lock casing including a cylindrical hole in center thereof for receiving an inner transmission assembly, two symmetrical flanges on both sides of said lock casing, and center of each said flange furnished with a cylindrical groove for receiving a retaining bar having a plurality of round grooves; said cylindrical groove being tangent to said cylindrical hole of said lock casing to form into a groove;
an inner transmission assembly including a plurality of tumbler disks mounted on a fixed member; said tumbler disks pushed with a spring towards one end plugged with a key; center of each said tumbler disk furnished with a hole for receiving a key surface of said key, and also furnished with a surface to be in contact with said key;
two retaining bars to be plugged into two symmetrical cylindrical grooves in two flanges respectively; each said retaining bar furnished with a plurality of round grooves; distance between two said round grooves being designed in correspondence to distance between two ring-shaped shoulders on said key surface of said key;
a key having cylindrical key surface and furnished with a plurality of ring-shaped shoulders in a staircase arrangement.

2. A lock device to be unlocked by pushing replaceable tumbler disks with a key thereof as claimed in claim 1, wherein said retaining bars mounted in said cylindrical grooves of said flanges and said key surfaces for pushing said tumbler disks are made with a CNC lathe having digital control.

3. A lock device to be unlocked by pushing replaceable tumbler disks with a key thereof as claimed in claim 1, wherein one end of said cylindrical hole of said lock casing is mounted with a limit ring and a retaining ring; outer edge of said limit ring furnished with symmetrical round notches, and a positioning bead; said retaining ring designed into a shape similar to that of said limit ring; pushing and turning round notches of said limit ring and said retaining ring to a position aligned with said cylindrical grooves on both sides of said lock casing so as to form into a through hole to facilitate said retaining bars to be removed and replaced with a new one so as to provide said lock device with s variable combination as desired.

4. A lock device to be unlocked by pushing replaceable tumbler disks with a key thereof as claimed in claim 1, wherein symmetrical cylindrical grooves in flanges on both sides of said lock casing are used for receiving said retaining bars respectively; one end of every said retaining bar being set on a level same as that of said cylindrical groove; said retaining bars plugged in said cylindrical grooves respectively, and outer side of said cylindrical groove furnished with a cut slot; said retaining bar furnished with a ring groove to facilitate said retaining bar to be pulled out upon replacing a new retaining bar.

5. A lock device to be unlocked by pushing replaceable tumbler disks with a key thereof as claimed in claim 1, wherein a key to unlock said lock device by pushing said tumbler disks is furnished with a plurality of ring-shaped shoulders on surface thereof; diameter of each of said ring-shaped shoulders and length of each cylindrical surface being designed in accordance with positions of said round grooves on said retaining bars.
